(19) United States
(12) Patent Application Publication
(10) Pub. No.: US 2006/0149918 A1
(43) Pub. Date: Jul. 6, 2006

(54) Memory with modifiable address map

(76) Inventors: John C. Rudelic, Folsom, CA (US); Dennis M. O'Connor, Chandler, AZ (US); Mark N. Fullerton, Austin, TX (US); Ray Richardson, Chandler, AZ (US)

Correspondence Address: LeMoine Patent Services, PLLC;C/O PortfolioIP, P.O. Box 52050, Minneapolis, MN, 55402, US

(21) Appl. No.: 11/323,473

(22) Filed: Dec. 30, 2005

Related U.S. Application Data
(63) Continuation-in-part of application No. 11/027,784, filed on Dec. 30, 2004.

(51) Int. Cl. G06F 12/10

(52) U.S. Cl. 711/202

(57) ABSTRACT

A memory device includes a flag register to modify the address map of the memory device based on the state of an input node on the memory device.

### RELATED APPLICATION

This application is a Continuation-in-Part of U.S. Nonprovisional application Ser. No. 11/027,784, entitled “Secure Memory Controller” by O'Connor et al., filed Dec. 30, 2004, which is incorporated herein by reference in its entirety for all purposes.

### FIELD

The present invention relates generally to integrated circuits, and more specifically to integrated circuits that include memory controllers.

### BACKGROUND

A microprocessor may include the ability to run in various modes. For example, some processor cores licensable from ARM Holdings plc, Cambridge, UK, can run in a user mode as well as a privileged mode. Privileged mode is typically used by operating system (OS) processes, and user mode is typically used by application processes.

Processors may also include the ability to run processes in a secure mode or non-secure mode, and may be able to access secure resources and non-secure resources. For example, secure processes may be able to access secure resources, and non-secure processes may be able to access non-secure resources.

### BRIEF DESCRIPTION OF THE DRAWINGS

FIG. 1 shows a block diagram of an electronic system;

FIGS. 2 and 3 show block diagrams of memory controllers;

FIG. 4 shows a flowchart in accordance with various embodiments of the present invention;

FIG. 5 shows a block diagram of a memory device;

FIGS. 6-8 show address maps for the memory device of FIG. 5;

FIG. 9 shows a flowchart in accordance with various embodiments of the present invention; and

FIG. 10 shows a system diagram in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

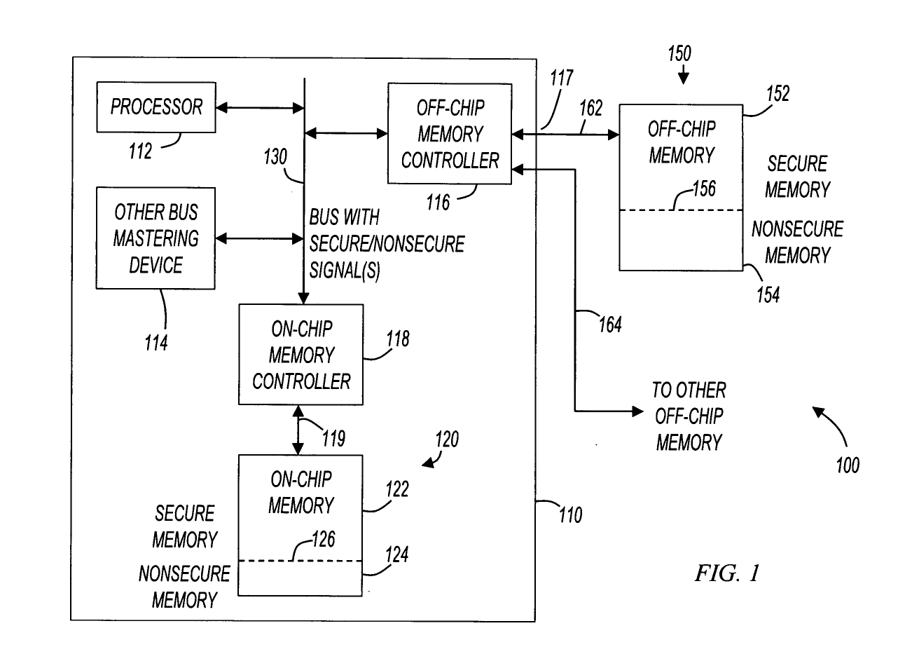

FIG. 1 shows a block diagram of an electronic system. System 100 includes system-on-chip (SOC) 110 and off-chip memory 150. In some embodiments, SOC 110 is an integrated circuit that includes many components. As shown in FIG. 1, SOC 110 includes processor 112, bus mastering device 114, memory controllers 116 and 118, and on-chip memory 120. As used herein, the term “system-on-chip” and the acronym “SOC” do not imply any particular level of integration. For example, in some embodiments, an SOC may include only a processor and a memory controller, or a bus mastering device and a memory controller. Also for example, in some embodiments, an SOC may include all of the components shown in FIG. 1 in addition to others.

Processor 112 and bus mastering device 114 are examples of bus mastering devices. For example, processor 112 may take control of bus 130 when communicating with other components within SOC 110. Also for example, other bus mastering device 114 may be a direct memory access (DMA) controller that may take control of bus 130 to communicate with other components within SOC 110. Any number of processors and bus mastering devices may be included in SOC 110 without departing from the scope of the present invention.

Processor 112 is any processor that may run in a secure mode or a non-secure mode. For example, processor 112 may be a processor core capable of running in a privileged mode and a user mode, or any number of modes with varying security levels. Likewise, bus mastering device 114 may be any other type of device that may run in a secure mode, a non-secure mode, or modes with varying security levels. Further, in some embodiments, bus mastering device 114 may be a bus mastering device that is limited to running in only a secure mode or only a non-secure mode.

Processor 112 and bus mastering device 114 communicate with memory controllers 116 and 118 over bus 130. In some embodiments, bus 130 includes one or more signal paths that carry information to identify the security mode in which the bus master is operating. For example, processor 112 may assert a single bit on bus 130 to signify whether processor 112 is operating in secure mode or non-secure mode. Also for example, processor 112 may assert a single bit on bus 130 to signify whether processor 112 is operating in user mode or a privileged mode. In other embodiments, processor 112 may assert a plurality of bits on bus 130 to indicate the security level at which processor 112 is operating. In these various embodiments, bus 130 may include a varying number of signal paths to accommodate the bits that signify the secure mode or security level.

Memory controllers 116 and 118 communicate with off-chip memory 150 and on-chip memory 120, respectively. Off-chip memory controller 116 provides an interface between a bus master in SOC 110 and off-chip memory 150, and on-chip memory controller 118 provides an interface between a bus master in SOC 110 and on-chip memory 120. For example, memory control signal lines 162 are coupled between memory controller 116 and memory 150, and memory control signal lines 119 are coupled between memory controller 118 and memory 120. Memory control signal lines 119 and/or 162 may include address, data, and control signals. The control signals may include signals to represent a mode in which the processor is running. For example, memory control signal lines 119 and/or 162 may include signal lines to indicate whether the processor is running in a secure mode or non-secure mode, a user mode or a privileged mode, or the like.

Memory controllers 116 and 118 receive information from, and provide information to, bus masters on bus 130. For example, a bus master may request that a memory controller perform one or more memory transactions. In addition, a bus master may provide information describing the security mode or security level of the process requesting a memory transaction. For example, processor 112 may be running in a secure mode, and may request on-chip memory controller 118 to perform a memory read or memory write in on chip memory 120.

As used herein, the term “secure transaction” refers to a transaction within SOC 110 in which one or more signals on bus 130 signifies that a bus master is operating in a secure mode. For example, when running a secure process, processor 112 may request a memory transaction through memory controller 116 or memory controller 118. If one or more secure/non-secure signals are asserted on bus 130, the transaction is referred to as a “secure transaction.”

In some embodiments, memory controllers 116 and 118 partition memory into secure partitions and non-secure partitions. For example, on chip memory controller 118 may partition on-chip memory 120 into secure memory partition 122 and non-secure memory partition 124, where the partitions are shown separated at boundary 126. Also for example, off-chip memory controller 116 may partition off-chip memory 120 into secure memory partition 152 and non-secure memory partition 154 where the partitions are shown separated at boundary 156.

The memory controllers may utilize various different apparatus to allow the specification of secure partitions and non-secure partitions. For example, in some embodiments of the present invention, each memory controller may maintain a range register and a direction bit. The range register may be programmed with a value that specifies a point in the memory that divides the secure partition from the non-secure partition. For example, memory controller 118 may have a range register programmed with a value corresponding to the boundary shown at 126, and memory controller 116 may have a range register programmed with a value corresponding to the boundary shown at 156. The direction bit may be programmed to specify which side of the boundary is secure memory, and which side is non-secure memory. Example embodiments of memory controllers using range registers and direction bits are described in more detail below.

In some embodiments, memory 120 and/or memory 150 also include various apparatus to allow the specification of various types of partitions. For example, blocks within each of the memory devices may have programmable flags associated therewith that allow the blocks to be defined as secure or non-secure blocks. Also for example, blocks within each of the memory devices may have programmable flags associated therewith that allow the blocks to be defined as user blocks or supervisor (privileged) blocks. Examples of memory embodiments are further described below with reference to later figures.

Off-chip memory controller 116 may control any number of memories. For example, as shown in FIG. 1, memory controller 116 provides memory control signal lines 162 to memory 120, and memory control signal lines 164 to other memories (not shown). Within SOC 110, memory control signal lines are provided between off-chip memory controller 116 and a chip boundary at 117.

Memory 120 and 150 may be of any type. For example, in some embodiments, the memories may be volatile memory such as dynamic random access memory (DRAM), static random access memory (SRAM), or the like. Also for example, in some embodiments, the memories may be nonvolatile memory such as Flash memory or any other suitable memory type. Also for example, memory 120 or memory 150 may be execute-in-place (XIP) Flash memory that holds program instructions to be fetched directly from the Flash memory.

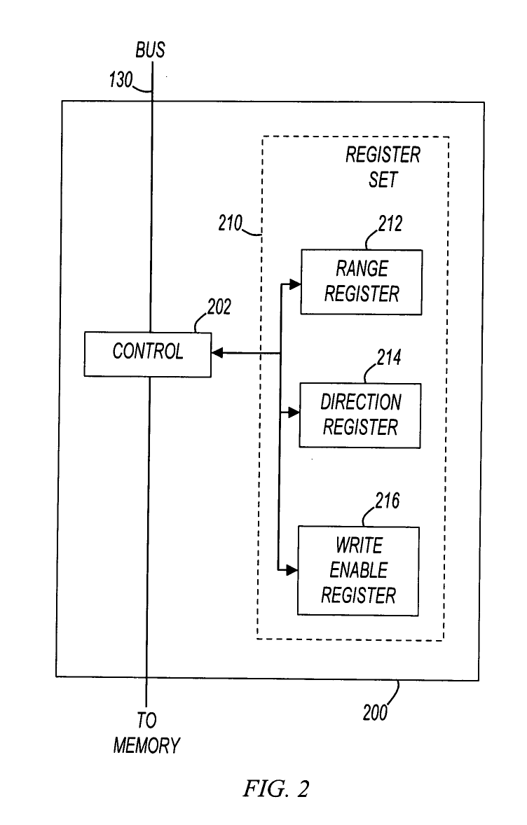

FIG. 2 shows a block diagram of a memory controller. In some embodiments, memory controller 200 may be utilized as a standalone memory controller, and in other embodiments, memory controller 200 may be a memory controller in a system on a chip. For example, memory controller 200 may be utilized as on-chip memory controller 118, or off-chip memory controller 116 (FIG. 1). Memory controller 200 includes control block 202 and register set 210. Register set 210 includes range register 212, direction register 214, and write enable register 216.

In some embodiments, register set 210 and control block 202 represent a memory partitioning mechanism that may be used to logically partition a memory into secure and non-secure partitions. For example, range register 212 may be used to hold the value of a boundary between secure and non-secure partitions such as the boundary at 126 in memory 120 or the boundary at 156 in memory 150. Also for example, direction register 214 may include a direction bit that signifies which direction the secure partition lies from the boundary, or which direction the non-secure partition lies from the boundary. In some embodiments, direction register 214 may include one direction bit, and in other embodiments, direction register 214 may include a plurality of bits. For example, in some embodiments, a direction bit may be included in a register that also includes other bits, such as control or status bits.

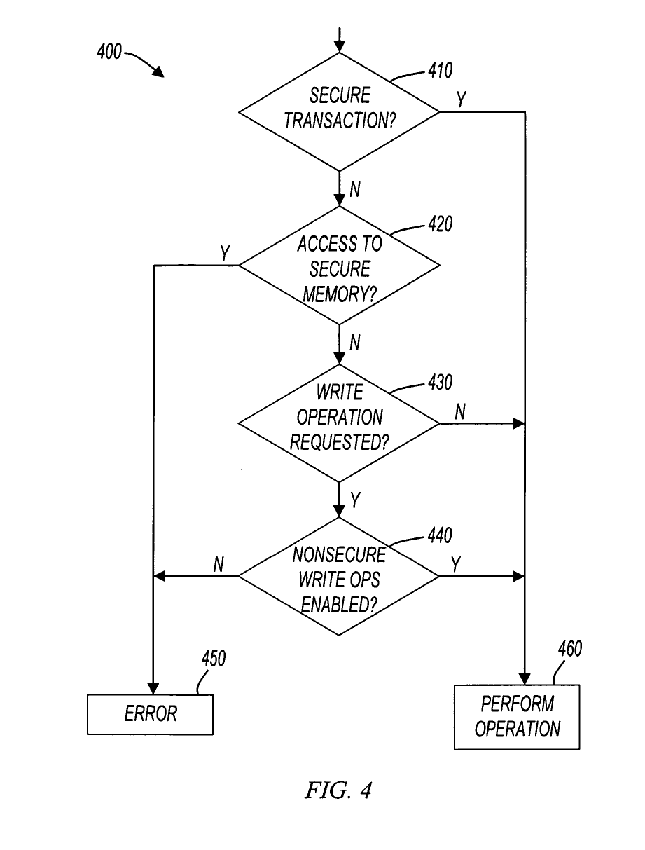

Write enable register 216 may be utilized to determine whether a particular memory partition may be written to by a non-secure process. For example, when memory controller 200 is performing a non-secure memory transaction that includes a write operation, control block 202 may consult the contents of write enable register 216 to determine if a non-secure write operation may write to a non-secure partition. More examples of this functionality are described below with reference to method 400 (FIG. 4).

Control block 202 may be any type of control circuit capable of performing operations within memory controller 200. For example, control block 202 may include a state machine, a microcontroller, or the like. In operation, control block 202 receives requests for memory transactions on bus 130. Further, control block 202 receives a secure/non-secure indication on bus 130 to indicate whether a secure process is requesting the memory transaction (a “secure transaction”) or a non-secure process is requesting the memory transaction (a “non-secure transaction”). In response to the memory transaction request and the status of the secure/non-secure signal(s) on bus 130, control block 202 either performs the transaction or refuses the transaction and reports an error back to the bus master on bus 130. For example, if a bus master running a secure process requests a memory transaction, control block 202 may perform the transaction regardless of the state of register set 210. Also for example, if a bus master running a non-secure process requests a memory transaction, control block 202 may conditionally perform the transaction based on the state of register set 210.

In some embodiments, control block 202 passes the secure/non-secure indication on to the memory. For example, a control block within on-chip memory controller 118 (FIG. 1) may pass a secure/non-secure indication received on bus 130 on to on-chip memory 120. Also in some embodiments, control block 202 may pass an indication of a processor mode on to the memory. For example, a control block within on-chip memory controller 118 may pass a user/supervisor indication received on bus 130 on to on-chip memory 120. Memory devices may utilize secure/non-secure and/or user/supervisor indications to provide access to various memory partitions based on memory access policies. In some embodiments, the memory access policies may be set by programming flags within the memory devices.

In some embodiments, register set 210 includes additional configuration bits. For example, additional configuration bits might be instantiated to control whether an error is signaled, and how it is signaled. Additional status registers may also exit to capture details (such as the address) of an aborted transaction to aid in determining the source of the error. In some embodiments, all of the resources within register set 210 are secure resources that can only be written by a secure transaction.

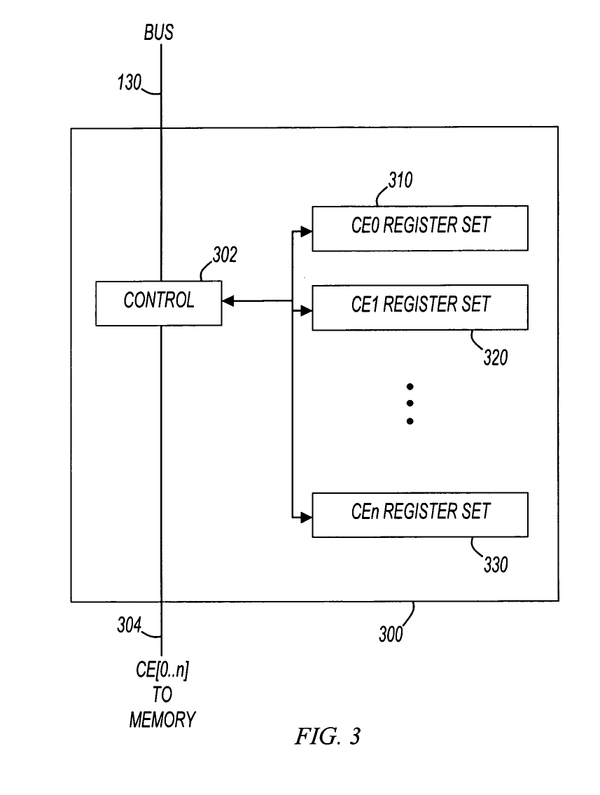

FIG. 3 shows a block diagram of a memory controller. In some embodiments, memory controller 300 may be utilized as a standalone memory controller, and in other embodiments, memory controller 300 may be a memory controller in a system on a chip. For example, memory controller 300 may be utilized as on-chip memory controller 118, or off-chip memory controller 116 (FIG. 1). Memory controller 300 includes control block 302 and register sets 310, 320, and 330.

In some embodiments, each of register sets 310, 320, and 330 includes a range register, a direction register, and a write enable register, or equivalent structures. In some embodiments, the operation of each of the register sets 310, 320, and 330 corresponds to register set 210 (FIG. 2). Further, each of register sets 310, 320, and 330 may represent an independent memory partitioning mechanism. FIG. 3 shows n+1 register sets, where n is any integer, and control block 302 provides n+1 chip enable (CE) signals to memories.

In operation, each register set may be used to logically partition a memory, and each signal in CE[0 . . . n] may be used to either allow a memory operation or disallow a memory operation. Although chip select signals are shown in FIG. 3, this is not a limitation of the present invention. For example, other types of signals may be used to allow or disallow memory operations in memories.

In some embodiments, memory controller 300 may be used to control multiple external memories. For example, memory controller 300 may be used as memory controller 116, and signal lines 304 may correspond to signal lines 162 and 164 (FIG. 1). In other embodiments, memory controller 300 may be used to control an internal memory. For example, memory controller 300 may be used as on-chip memory controller 118, and signal lines 304 may correspond to signal lines 119 (FIG. 1). In these embodiments, memory 120 (FIG. 1) may include multiple physically separate memory blocks, or may include one large physical memory block that may be divided into multiple secure partitions and multiple non-secure partitions.

In some embodiments, memory controller 300 may be utilized to partition a memory into partitions with varying levels of security. For example, registers within register sets 310, 320, and 330 may be utilized to define a range of locations within a memory for each security level. In these embodiments, bus 130 may includes signal lines that express the level of security of the current memory transaction, (the “memory transaction security level”), and control block 302 may be responsive to those signal lines. For example, control block 302 may include circuitry to allow access to a partition when the memory transaction security level is appropriate for that partition. Further, control block 302 may include circuitry to block access to a partition when the memory transaction security level is inappropriate for that partition. In some embodiments, a memory transaction security level may be appropriate when it matches the security level of the partition, and in other embodiments, a memory transaction security level may be appropriate when it has a value relative to the security level of the partition. For example, the memory transaction security level may be appropriate for a partition when it is equal to or greater than the security level of the partition, or if it is greater than the security level of the partition.

Memory controllers, processors, memories, systems-on-chip, registers, and other embodiments of the present invention can be implemented in many ways. In some embodiments, they are implemented in integrated circuits. In some embodiments, design descriptions of the various embodiments of the present invention are included in libraries that enable designers to include them in custom or semi-custom designs. For example, any of the disclosed embodiments can be implemented in a synthesizable hardware design language, such as VHDL or Verilog, and distributed to designers for inclusion in standard cell designs, gate arrays, custom devices, or the like. Likewise, any embodiment of the present invention can also be represented as a hard macro targeted to a specific manufacturing process. For example, memory controller 118 (FIG. 1) may be represented as polygons assigned to layers of an integrated circuit.

FIG. 4 shows a flowchart in accordance with various embodiments of the present invention. In some embodiments, method 400, or portions thereof, is performed by a memory controller or a control block within a memory controller, embodiments of which are shown in the various figures. In other embodiments, method 400 is performed by a control circuit, an integrated circuit, a system on a chip, or an electronic system. Method 400 is not limited by the particular type of apparatus or software element performing the method. The various actions in method 400 may be performed in the order presented, or may be performed in a different order. Further, in some embodiments, some actions listed in FIG. 4 are omitted from method 400.

Method 400 is shown beginning with block 410. At 410, method 400 determines if the current memory transaction is a secure transaction. For example, a control block in a memory controller may determine whether a transaction is secure or non-secure based on the value of secure/non-secure signal(s) on a bus. If the transaction is secure, the operation is performed at 460. For example, if the transaction includes a read operation or a write operation in either secure or non-secure memory, then the operation will be performed as long as the transaction is secure.

If the transaction is not secure, then at 420, method 400 determines whether the memory transaction is attempting to access secure memory. In some embodiments, this may be accomplished by comparing a target address of the memory transaction with a value in a range register, such as range register 212 (FIG. 2). If the non-secure memory transaction is attempting to access secure memory, then an error condition occurs at 450. The error condition at 450 may cause the transaction to be ignored, or may raise an exception to a processor, or may perform some other error reporting or processing function. If the non-secure transaction is not attempting to access secure memory, then method 400 proceeds to 430.

At 430, method 400 determines whether a write operation is requested as part of the memory transaction. If a write operation is not requested, then the operation is performed at 460. If a write operation is requested, then at 440, method 400 determines if write operations are enabled for non-secure transactions. In some embodiments, this may correspond to a memory controller checking the contents of a write enable register such as write enable register 216 (FIG. 2). If non-secure write operations are enabled, then the operation is performed at 460, and if write operations are disabled, then an error condition occurs at 450.

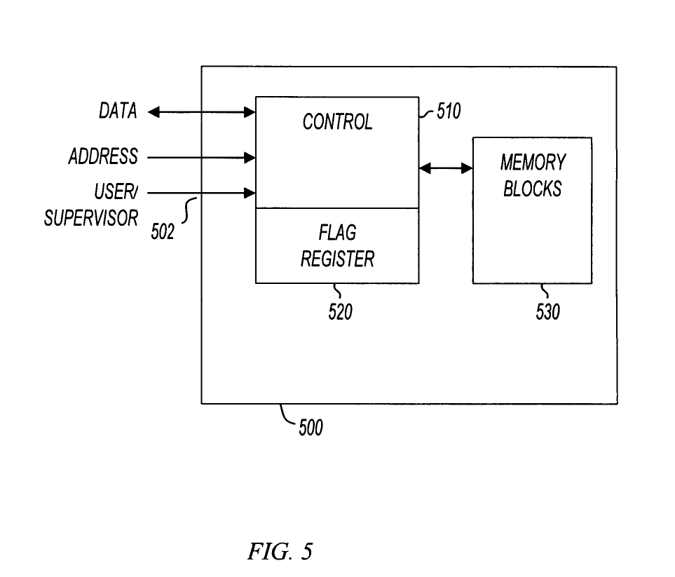

FIG. 5 shows a diagram of a memory device. Memory device 500 includes memory blocks 530, control circuit 510, and flag register 520. Memory device 500 may include many other circuits or functional blocks. Memory device 500 may be an on-chip memory such as memory 120 (FIG. 1), or may be an off-chip memory such as memory 150. As shown in FIG. 5, memory device 500 receives a user/supervisor control signal on input node 502. In some embodiments, many more control signals are received. For example, in some embodiments, a secure/non-secure signal is received. Also for example, in some embodiments, chip select signals, clock signals, command lines, and other control signals are received.

Control circuit 510 receives address, data, and control signals, and controls the access to memory blocks 530. For example, control circuit 510 may gate access to different memory blocks based on various criteria. Also for example, control circuit 510 may change the decoding of the address signals based on various criteria to rearrange the address map of memory device 500. Also for example, control circuit 510 may make one or more memory blocks conditionally visible or invisible based on various criteria. The criteria used to influence the operation of control circuit 510 may be of different types.

Memory blocks 530 may include any number of blocks of memory. In some embodiments, memory blocks 530 are individually addressable, and flag register 520 includes flags that correspond to each block of memory. For example, flag register 520 may include flags to assign individual memory blocks to user mode or supervisor mode. Access to the various memory blocks may be granted or denied based on the state of the corresponding flag, and also on the state of the user/supervisor signal on input node 502. In addition, the address map of memory device 500 may be modified based on the state of flags, and also on the state of the user/supervisor signal on input node 502.

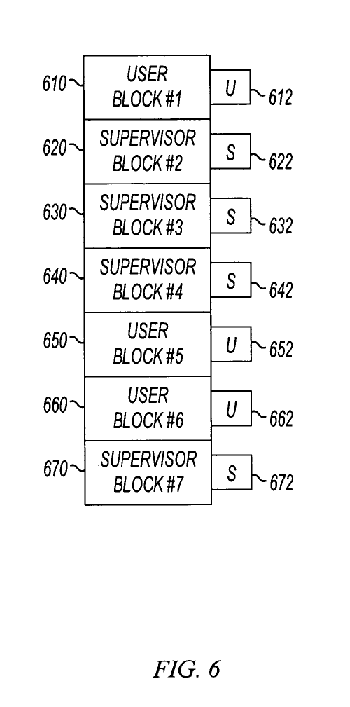

FIGS. 6-8 show address maps of the memory device of FIG. 5. As shown in FIG. 6, the memory device includes memory blocks 610, 620, 630, 640, 650, 660, and 670. The memory device also includes flag registers 612, 622, 632, 642, 652, 662, and 672. The memory blocks shown in FIG. 6 correspond to memory blocks 530 (FIG. 5), and the flag registers shown in FIG. 6 correspond to flag register 520 (FIG. 5).

Each of the flag registers shown in FIG. 6 is associated with a corresponding memory block. For example, flag register 612 is associated with memory block 610, and flag register 622 is associated with memory block 620. The flag registers are programmable with a bit of information to indicate a mode assigned to the corresponding memory block. For example, the flag registers shown in FIG. 6 may be programmed with either a “U” or an “S” to indicate user or supervisor, respectively. In some embodiments, a “U” may be indicated by a first state of a single digital bit, and an “S” may be indicated by a second state of the same digital bit. In other embodiments, the flag register may be programmed to indicate a secure/non-secure memory block. In still further embodiments, each flag register includes multiple bits to provide more than two possible programmed values.

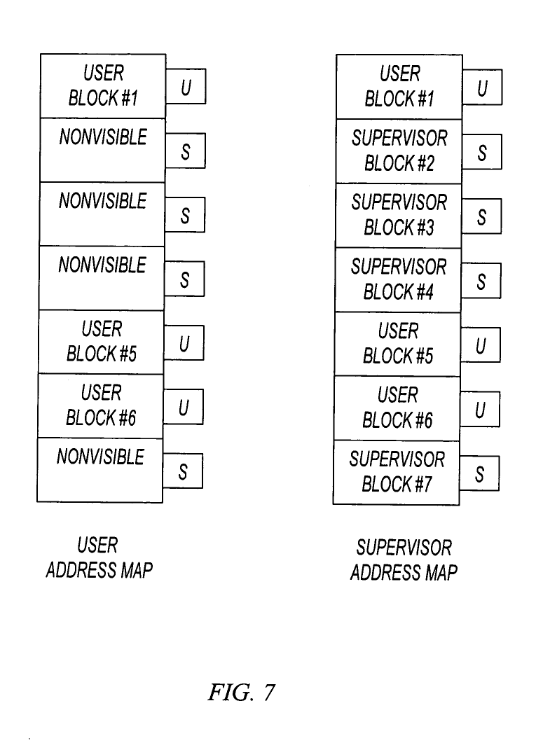

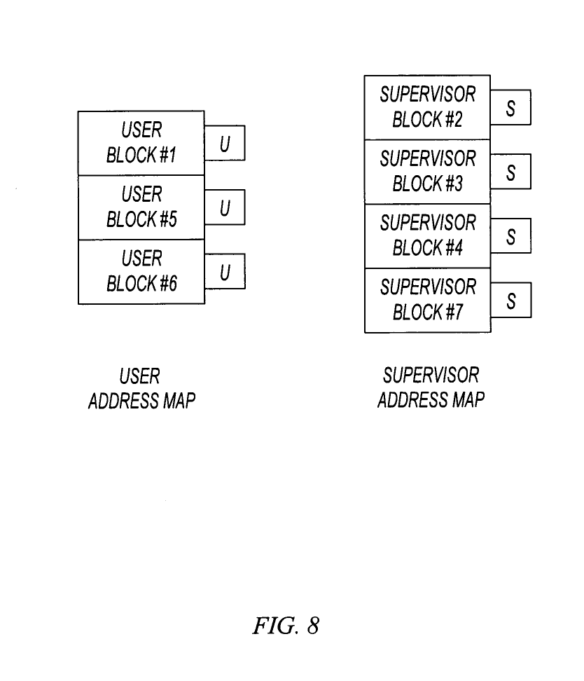

As shown in FIG. 6, flag registers 612, 652, and 662 are programmed with a “U,” and flag registers 622, 632, 642, and 672 are programmed with an “S.” As a result, memory blocks 610, 650, and 660 are considered user blocks, and memory blocks 620, 630, 640, and 670 are considered supervisor blocks. The address map of the memory device may be altered based on the programmed flag values and the state of the user/supervisor signal on input node 502 (FIG. 5). For example, in some embodiments, when the user/supervisor signal state is set to user, only the user blocks are visible in the address map, and when the user/supervisor signal is set to supervisor, both the user and supervisor blocks are visible. Also for example, in some embodiments, when the user/supervisor signal state is set to user, only the user blocks are visible in the address map, and when the user/supervisor signal is set to supervisor, only the supervisor blocks are visible. Various examples are described further below with reference to FIGS. 7 and 8.

FIG. 7 represents embodiments in which all memory blocks are visible when the user/supervisor signal is set to supervisor, and only the user blocks are visible when the user/supervisor signal is set to user. In these embodiments, the memory device presents one of two possible address maps based on the state of the user/supervisor signal, where one address map is a subset of the other. In some embodiments, the user/supervisor partitioning shown in FIG. 7 is combined with the secure/non-secure partitioning provided by memory controllers as described above. In these embodiments, each memory block may be divided into secure/non-secure partitions regardless whether it is a user block or a supervisor block.

FIG. 8 represents embodiments in which the user and supervisor blocks are swapped in the address mapped based on the state of the user/supervisor signal. In these embodiments, one set of blocks is visible in user mode, and another, independent, set of blocks is visible in supervisor mode. Accordingly, the two address maps represented by FIG. 8 are said to be “mutually exclusive.” In these embodiments, the different “views” of the memory device provide for secure hidden execution. For example, software executed from the memory device in supervisor mode is hidden from view when in user mode.

The behavior of the address map (FIG. 7 vs. FIG. 8) may be influenced by a control circuit within the memory. For example, referring now back to FIG. 5, control circuit 510 may include logic to determine the address map behavior. Further, the behavior may be selectable through control registers. When one control value is written, the address map may behave as shown in FIG. 7, and when another control value is written, the address map may behave as shown in FIG. 8.

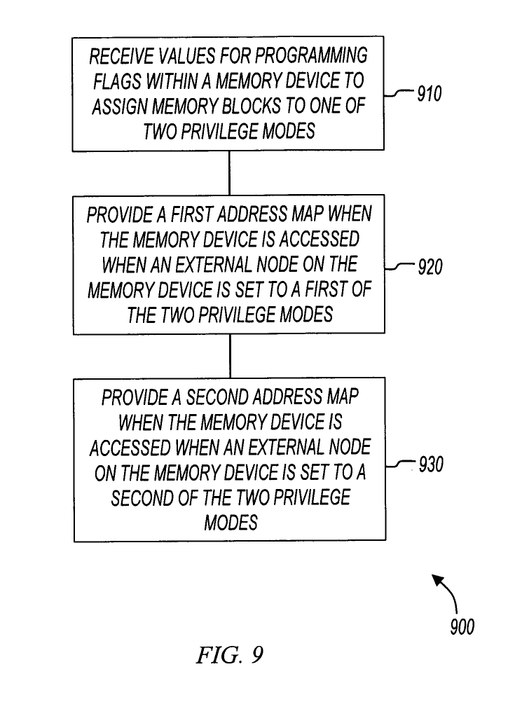

FIG. 9 shows a flowchart in accordance with various embodiments of the present invention. In some embodiments, method 900, or portions thereof, is performed by a memory device or a control block within a memory device, embodiments of which are shown in the various figures. In other embodiments, method 900 is performed by a control circuit, an integrated circuit, a system on a chip, or an electronic system. Method 900 is not limited by the particular type of apparatus or software element performing the method. The various actions in method 900 may be performed in the order presented, or may be performed in a different order. Further, in some embodiments, some actions listed in FIG. 9 are omitted from method 900.

Method 900 is shown beginning with block 910 in which values are received for programming flags within a memory device to assign memory blocks to one of two privilege modes. The actions of 910 correspond to a memory device such as memory device 500 (FIG. 5) receiving values to program flag register 520. In some embodiments, the values correspond to a user mode and a supervisor mode. In other embodiments, the values correspond to a secure mode and a non-secure mode.

At 920, a first address map is provided when the memory device is accessed when an external node on the memory device is set to a first of the two privilege modes, and at 930, a second address map is provided when the memory device is accessed when an external node on the memory device is set to a second of the two privilege modes. In some embodiments, the two address maps correspond to the address maps shown in FIGS. 7 and 8.

In some embodiments, the first address map is a subset of the second address map. For example, the first address map may correspond to the user address map shown in FIG. 7, and the second address map may correspond to the supervisor address map shown in FIG. 7. In other embodiments, the first and second address maps are mutually exclusive. For example, the first address map may correspond to the user address map shown in FIG. 8, and the second address map may correspond to the supervisor map shown in FIG. 8.

In further embodiments, method 900 may include receiving configuration information to set address map behavior. For example, configuration information may be used to toggle address map behavior between two maps being mutually exclusive and two maps not being mutually exclusive.

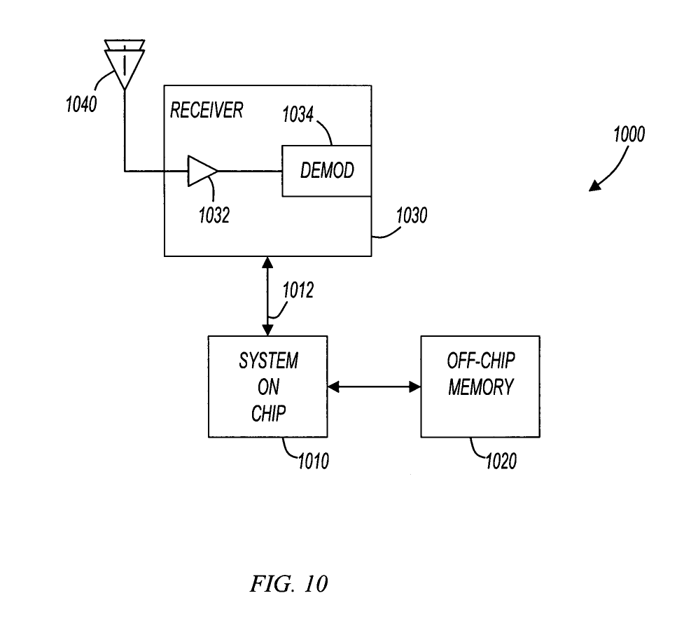

FIG. 10 shows a system diagram in accordance with various embodiments of the present invention. FIG. 10 shows system 1000 including system-on-chip (SOC) 1010, off-chip memory 1020, receiver 1030, and antennas 1040. SOC 1010 may include one or more memory controllers capable of partitioning memory into secure and non-secure partitions as described with reference to the various embodiments of the invention.

In systems represented by FIG. 10, SOC 1010 is coupled to receiver 1030 by conductor 1012. Receiver 1030 receives communications signals from antennas 1040 and also communicates with SOC 1010 on conductor 1012. In some embodiments, receiver 1030 provides communications data to SOC 1010. Also in some embodiments, SOC 1010 provides control information to receiver 1030 on conductor 1012.

Example systems represented by FIG. 10 include cellular phones, personal digital assistants, wireless local area network interfaces, and the like. Many other systems uses for SOC 1010 exist. For example, SOC 1010 may be used in a desktop computer, a network bridge or router, or any other system without a receiver.

Receiver 1030 includes amplifier 1032 and demodulator (demod) 1034. In operation, amplifier 1032 receives communications signals from antennas 1040, and provides amplified signals to demod 1034 for demodulation. For ease of illustration, frequency conversion and other signal processing is not shown. Frequency conversion can be performed before or after amplifier 1032 without departing from the scope of the present invention. In some embodiments, receiver 1030 may be a heterodyne receiver, and in other embodiments, receiver 1030 may be a direct conversion receiver. In some embodiments, receiver 1030 may include multiple receivers. For example, in embodiments with multiple antennas 1040, each antenna may be coupled to a corresponding receiver.

Receiver 1030 may be adapted to receive and demodulate signals of various formats and at various frequencies. For example, receiver 1030 may be adapted to receive time domain multiple access (TDMA) signals, code domain multiple access (CDMA) signals, global system for mobile communications (GSM) signals, orthogonal frequency division multiplexing (OFDM) signals, multiple-input-multiple-output (MIMO) signals, spatial-division multiple access (SDMA) signals, or any other type of communications signals. The various embodiments of the present invention are not limited in this regard.

Antennas 1040 may include one or more antennas. For example, antennas 1040 may include a single directional antenna or an omni-directional antenna. As used herein, the term omni-directional antenna refers to any antenna having a substantially uniform pattern in at least one plane. For example, in some embodiments, antennas 1040 may include a single omni-directional antenna such as a dipole antenna, or a quarter wave antenna. Also for example, in some embodiments, antennas 1040 may include a single directional antenna such as a parabolic dish antenna or a Yagi antenna. In still further embodiments, antennas 1040 include multiple physical antennas. For example, in some embodiments, multiple antennas are utilized for multiple-input-multiple-output (MIMO) processing or spatial-division multiple access (SDMA) processing.

Memory 1020 may be any type of memory including, but not limited to, volatile memory, nonvolatile memory, RAM, ROM, Flash memory, or any other type of memory. In some embodiments, memory 1020 is logically partitioned into secure and non-secure partitions by a memory controller within SOC 1010. In other embodiments, memory 1020 is partitioned into partitions having varying levels of security. In still further embodiments, memory 1020 includes programmable flags to modify an address map of the memory.

Although SOC 1010 and receiver 1030 are shown separate in FIG. 10, in some embodiments, the circuitry of SOC 1010 and receiver 1030 are combined in a single integrated circuit. Furthermore, receiver 1030 can be any type of integrated circuit capable of processing communications signals. For example, receiver 1030 can be an analog integrated circuit, a digital signal processor, a mixed-mode integrated circuit, or the like.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. A memory device comprising:
a plurality of memory blocks;
a plurality of programmable flags, wherein each of the memory blocks is associated with a corresponding one of the plurality of programmable flags; and
a control circuit to gate access to each of the plurality of memory blocks based on a state of the corresponding programmable flag and a state of an input to the memory device.

2. The memory device of claim 1 wherein the control circuit modifies an address map of the memory device into two mutually exclusive blocks of memory based on the state of the input.

3. The memory device of claim 1 wherein the control circuit modifies an address map of the memory device into a first map including all of the plurality of memory blocks, and into a second map including a subset of the plurality of memory blocks.

4. The memory device of claim 1 wherein the memory device comprises a nonvolatile memory.

5. The memory device of claim 4 wherein the memory device comprises a FLASH memory device.

6. An integrated circuit comprising a memory device having a plurality of blocks conditionally visible in an address space based on a logical state of an input node and based on flag values programmed in the memory device, wherein each of the flag values corresponds to one of the plurality of blocks.

7. The integrated circuit of claim 6 wherein each of the plurality of blocks is visible in the address space when the logical state of the input node matches a corresponding flag value.

8. The integrated circuit of claim 6 wherein each of the plurality of blocks is not visible in the address space when the logical state of the input node does not match a corresponding flag value.

9. The integrated circuit of claim 6 wherein all of the plurality of blocks are visible in the address space when the logical state of the input node is in a first state, and only blocks having associated flag values matching a second state are visible when the logical state of the input node is in the second state.

10. The integrated circuit of claim 6 further comprising a memory controller coupled to provide a secure/non-secure indication on the input node of the memory device.

11. The integrated circuit of claim 6 further comprising a memory controller coupled to provide a user/supervisor indication on the input node of the memory device.

12. The integrated circuit of claim 6 further comprising a memory controller comprising a memory partitioning mechanism to partition the memory device into secure and non-secure partitions wherein the memory partitioning mechanism comprises at least one register to define a range of locations in the memory device.

13. A method comprising:
receiving values for programmable flags within a memory device to assign memory blocks to one of two privilege modes;
providing a first address map when the memory device is accessed when an external node on the memory device is set to a first of the two privilege modes; and
providing a second address map when the memory device is accessed when the external node on the memory device is set to a second of the two privilege modes.

14. The method of claim 13 wherein the first address map is a subset of the second address map.

15. The method of claim 13 wherein the first address map and second address map are mutually exclusive.

16. The method of claim 13 further comprising receiving configuration information to set address map behavior, wherein in a first behavior, the first address map is a subset of the second address map, and in a second behavior, the first address map and the second address map are mutually exclusive.

17. A system comprising:
an antenna;
a receiver coupled to the antenna;
a processor coupled to the receiver; and
a memory device coupled to the processor, the memory device comprising a plurality of memory blocks, a plurality of programmable flags, wherein each of the memory blocks is associated with a corresponding one of the plurality of programmable flags, and a control circuit to gate access to each of the plurality of memory blocks based on a state of the corresponding programmable flag and a state of an input to the memory device.

18. The system of claim 17 wherein the control circuit modifies an address map of the memory device into two mutually exclusive blocks of memory based on the state of the input.

19. The system of claim 17 wherein the control circuit modifies an address map of the memory device into a first map including all of the plurality of memory blocks, and into a second map including a subset of the plurality of memory blocks.

20. The system of claim 17 wherein the memory device comprises a nonvolatile memory.
